(19) United States
(12) Patent Application Publication
(10) Pub. No.: US 2007/0071194 A1
(43) Pub. Date: Mar. 29, 2007

(54) Communication system, communication terminal device, and program

(75) Inventor: Hideki Nogawa, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/480,523

(22) Filed: Jul. 5, 2006

(30) Foreign Application Priority Data
Jul. 4, 2005 (JP) 2005-195339

(51) Int. Cl. H04M 11/00

(52) U.S. Cl. 379/100.17

(57) ABSTRACT

A communication system comprises a plurality of communication terminal devices interconnected via a network. The communication system is configured such that information is sent and received between the plurality of communication terminal devices. The plurality of communication terminal devices comprise a first communication terminal device including a first storing system that stores shared data to be shared among the plurality of communication terminal devices, and a first response system that sends the shared data to another communication terminal device in response to a request for the shared data being received from said another communication terminal device, and a second communication terminal device including a requesting system that requests the shared data of the first communication terminal device, and an obtaining system that obtains the shared data from the first communication terminal device in response to the requesting system requesting the shared data.

### CROSS-REFERENCE TO RELATED APPLICATION

This application claims priority under 35 U.S.C. §119 from Japanese Patent Application No. 2005-195339, filed on Jul. 4, 2005. The entire subject matter of the application is incorporated herein by reference.

### BACKGROUND

1. Technical Field

The following description relates to a communication system configured with two or more communication terminal devices interconnected via a network that are configured to send and receive information therebetween, the communication terminal device, and a program.

2. Related Art

Conventionally, in a communication system configured with two or more communication terminal devices interconnected via a network, data stored in each of the communication terminal devices are sent, received, and shared between the communication terminal devices.

In such a conventional method, when the data shared between the communication terminal devices are updated in one of the communication terminal devices, the shared data as updated are sent to the other communication terminal devices.

Further, the communication system, for example, is configured such that, when a communication terminal device that has not been connected with the network is connected therewith, the terminal device can receive the shared data sent from one of the other communication terminal devices.

Thus, the latest shared data can always be shared between the communication terminal devices.

### SUMMARY

An advantage of the present invention is an improved communication system configured such that information is sent and received between communication terminal devices, wherein shared data can smoothly be shared between the communication terminal devices.

### BRIEF DESCRIPTION OF THE ACCOMPANYING DRAWINGS

FIG. 1 is a block diagram showing a configuration of a communication system according to one or more aspects of the present invention.

FIG. 2 is a flowchart showing a procedure of a main process to be executed by a CPU of an MFP in accordance with one or more aspects of the present invention.

FIG. 3 is a flowchart showing a procedure of a judging process to be executed by the CPU of the MFP in accordance with one or more aspects of the present invention.

FIG. 4 is a flowchart showing a procedure of a main MFP process to be executed by a CPU of a main MFP in accordance with one or more aspects of the present invention.

FIG. 5 is a flowchart showing a procedure of a sub MFP process to be executed by a CPU of a sub MFP in accordance with one or more aspects of the present invention.

FIG. 6 is a flowchart showing a procedure of a data inquiring process to be executed by the CPU of the sub MFP in accordance with one or more aspects of the present invention.

FIG. 7 is a flowchart showing a procedure of a specifying-requesting process to be executed by the CPU of the sub MFP in accordance with one or more aspects of the present invention.

FIG. 8 is a flowchart showing a procedure of a broadcast response process to be executed by the CPU of the sub MFP in accordance with one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

General Overview

According to aspects of the present invention, there is provided a communication system comprising a plurality of communication terminal devices interconnected via a network, the communication system being configured such that information can be sent and received between the plurality of communication terminal devices. The plurality of communication terminal devices comprises a first communication terminal device including a first storing system configured to store shared data to be shared among the plurality of communication terminal devices, and a first response system configured to send the shared data stored in the first storing system to another communication terminal device, in response to a request for the shared data being received from said another communication terminal device, and a second communication terminal device including a requesting system configured to request the shared data of the first communication terminal device, and an obtaining system configured to obtain the shared data to be sent from the first communication terminal device in response to the requesting system requesting the shared data of the first communication terminal device.

According to some aspects of the invention, when the second communication terminal device requests the shared data of the first communication terminal device, the first communication terminal device sends the shared data to the second communication terminal device. Namely, the first communication terminal device does not unilaterally send the shared data to the second communication terminal device. Therefore, when the second communication terminal device does not have a storage capacity sufficient for storing the shared data, or the shared data are unnecessary for the second communication terminal device, it is possible to prevent the shared data from being sent from the first communication terminal device.

On the other hand, when the second communication terminal device can receive the shared data, or the shared data are necessary for the second communication terminal device, the shared data are sent from the first communication terminal device in response to the shared data being requested of the first communication terminal device storing the shared data. Accordingly, the second communication terminal device can receive the shared data in a timely fashion when the second communication terminal device needs the shared data.

Thus, when the shared data are sent to the second communication terminal device from the first communication terminal device, the second communication terminal device is always able to receive the shared data. Hence, the shared data are smoothly shared between the communication terminal devices.

Optionally, the first storing system may be configured to store a plurality of shared data as the shared data. Optionally, the second communication terminal device may further include a specifying system configured to specify shared data to be requested by the requesting system from the plurality of shared data. Still optionally, the requesting system may be configured to request the shared data specified by the specifying system of the first communication terminal device. Further optionally, the first response system may be configured to send the shared data specified by the specifying system to the second communication terminal device.

Thus, when the first communication terminal device stores the plurality of shared data, the second communication terminal device may include the specifying system configured to specify shared data to be requested from the plurality of shared data. Thereby, since the second communication terminal device can obtain necessary shared data, it is possible to prevent a communication channel and/or the storage capacity of the second communication terminal device from being wastefully occupied.

It is noted that, when specifying the shared data to be requested, the specifying system may be configured to automatically specify the shared data, or may be configured to specify the shared data based upon an input by the user.

Optionally, the second communication terminal device may further include an updating system configured to update the shared data obtained by the obtaining system, and a sending system configured to send the shared data updated by the updating system to the first communication terminal device, in response to the updating system updating the shared data. In this case, the first communication terminal device may further include a notifying system configured to send information representing that the shared data have been updated to the other communication terminal devices, in response to the shared data as updated being received from the second communication terminal device.

According to some aspects of the invention, the communication system is configured user-friendly such that the user can update the shared data on the second communication terminal device. It is noted that, when updating the shared data, the updating system may be configured to update the shared data based upon the input by the user, or may be configured to automatically update the shared data.

In some aspects of the invention, the shared data updated in the second communication terminal device are sent to the first communication terminal device. Then, the first communication terminal device sends the information representing that the shared data have been updated to the other communication terminal devices.

Accordingly, if each of the other communication terminal devices has the same functions as the second communication terminal device, such a communication terminal device can request the shared data, as updated, of the first communication terminal device to receive the shared data as updated, and obtain the shared data as updated. Therefore, when the shared data are updated, the shared data can be shared among the communication terminal devices.

Optionally, the second communication terminal device may further include a second storing system configured to store shared data to be shared among the plurality of communication terminal devices, a second response system configured to send the shared data stored in the second storing system to another communication terminal device, in response to a request for the shared data being received from said another communication terminal device, a judging system configured to judge whether the first communication terminal device exists on the network, when the requesting system requests the shared data of the first communication terminal device, and a setting system configured to set the second communication terminal device to serve as the first communication terminal device, in response to the judging system judging that none of the first communication terminal device exists on the network.

In some aspects of the invention, even though the first communication terminal device cannot operate due to some sort of trouble, or the connection thereof with the network is broken for maintenance, and thereby, the first communication terminal device does not exist on the network, it is possible to allow the second communication terminal device to serve as the first communication terminal device, since the second communication terminal device includes the storing system and the response system in the same manner as the first communication terminal device.

For example, the following problem can be supposed. Namely, even though the request for the shared data is issued from another communication terminal device having the same function as the second communication terminal device to the first communication terminal device, the communication terminal device cannot receive the response in the case of no first communication terminal device on the network. Consequently, continuous transmission of the request from the communication terminal device as a requesting source may cause the communication channel to be occupied, or cause the communication terminal device to freeze. The above problem can be prevented by the present invention. Therefore, a reliable communication system can be provided.

Optionally, the second communication terminal device may further include a judging system configured to judge whether the first communication terminal device exists on the network when the requesting system requests the shared data of the first communication terminal device, and an instruction sending system configured to send an instruction for instructing any of the other communication terminal devices on the network to serve as the first communication terminal device in response to the judging system judging that none of the first communication terminal device exists on the network.

According to some aspects of the invention, when the first communication terminal device cannot operate due to some sort of trouble, or the connection thereof with the network is broken for maintenance, and thereby, the first communication terminal device does not exist on the network, it is possible to allow any of the communication terminal devices on the network to serve as the first communication terminal device. Hence, there can be provided a more reliable communication system.

Optionally, the communication system may further comprise a third communication terminal device configured capable of requesting the shared data of another communication terminal device. In this case, the second communication terminal device may further include an informing system configured to send information representing an address of the first communication terminal device to the third communication terminal device in response to the third communication terminal device requesting the shared data of the second communication terminal device. Still optionally, the third communication terminal device may be configured to request the shared data of the first communication terminal device corresponding to the address represented by the information sent from the informing system.

In some aspects of the invention, the third communication terminal device can request the shared data of any of the communication terminal devices. For instance, when the third communication terminal device requests the shared data of the second communication terminal device, the second communication terminal device sends information representing the address of the first communication terminal device to the third communication terminal device. Then, the third communication terminal device requests the shared data of the first communication terminal device corresponding to the address represented by the information. The third communication terminal device can thereby certainly obtain the shared data from the first communication terminal device.

According to some aspects of the invention, even when the communication system is configured with three or more communication terminal devices as aforementioned, if each of the communication terminal devices can request the shared data of one of the other communication terminal devices (in other words, if each of the communication terminal devices have the functions of the third communication terminal device), the shared data can smoothly be shared among the communication terminal devices. It is noted that there is cited as the address of the first communication terminal device an IP address.

Optionally, the shared data may include at least one of a telephone number, an e-mail address, and a facsimile number that are set communicable between the plurality of communication terminal devices.

According to another aspect of the present invention, there is provided a communication terminal device included in a communication system configured with a plurality of communication terminal devices interconnected via a network such that information can be sent and received between the plurality of communication terminal devices, the communication terminal device comprising: a storing system configured to store shared data to be shared among the plurality of communication terminal devices; and a response system configured to send the shared data stored in the storing system to another communication terminal device, in response to a request for the shared data being received from said another communication terminal device.

According to a further aspect of the present invention, there is provided a communication terminal device included in a communication system configured with a plurality of communication terminal devices interconnected via a network such that information can be sent and received between the plurality of communication terminal devices, the communication terminal device comprising: a requesting system configured to request shared data of a first communication terminal device that includes a storing system configured to store the shared data to be shared among the plurality of communication terminal devices; and an obtaining system configured to obtain the shared data to be sent from the first communication terminal device in response to the requesting system requesting the shared data of the first communication terminal device.

According to some aspects of the invention, by employing the above communication terminal devices, the aforementioned communication system can be configured. Thereby, it can bring the same effects as aforementioned.

According to a further aspect of the present invention, there is provided a computer program product comprising instructions configured readable by a computer, the computer being interconnected with at least one communication terminal device via a network, the computer having a storing system configured to store shared data to be shared with the at least one communication terminal device, the instructions causing the computer to serve as: a response system configured to send the shared data stored in the storing system to the at least one communication terminal device in response to a request for the shared data being received from the at least one communication terminal device; a requesting system configured to request the shared data of the at least one communication terminal device; and an obtaining system configured to obtain the shared data to be sent from the at least one communication terminal device in response to the requesting system requesting the shared data of the at least one communication terminal device.

According to some aspects of the invention, by employing the computer program product configured as aforementioned, it is possible to allow the computer to serve as each of the first, second, and third communication terminal devices as aforementioned. Thereby, it can bring the same effects as aforementioned.

Illustrative Aspects

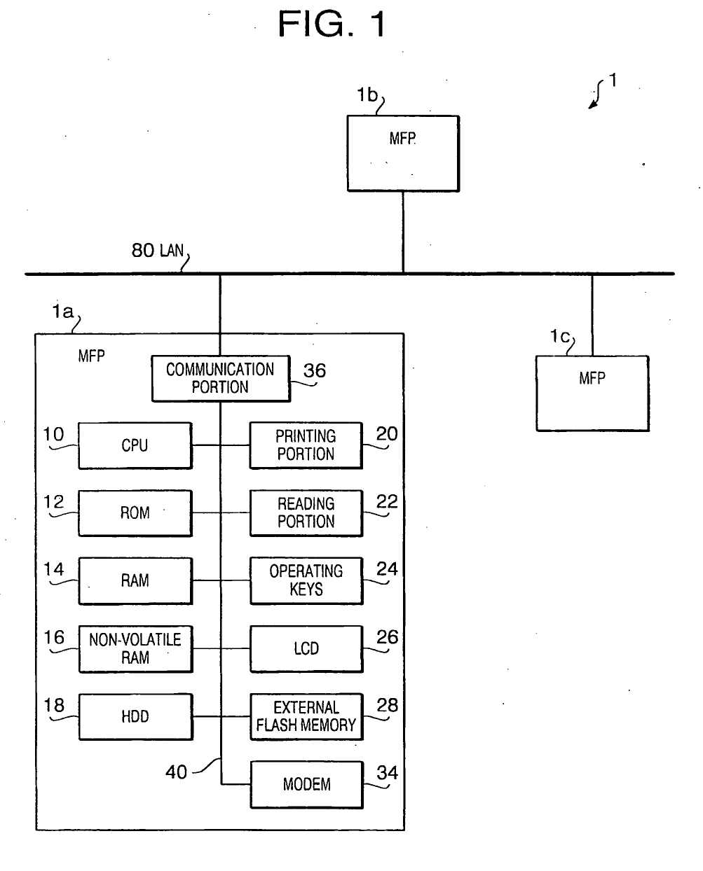

Hereinafter, illustrative aspects according to the present invention will be described with reference to the accompanying drawings. FIG. 1 is a block diagram showing a configuration of a communication system 1 in an illustrative aspect according to the present invention. As shown in FIG. 1, in the illustrative aspect of the present invention, three Multi Function Peripherals (MFPs) 1a, 1b, and 1c are communicably interconnected via a LAN 80.

Hereinafter, configurations of the MFPs 1a, 1b, and 1c will be explained in detail. It is noted that, although only the MFP 1a will be described among the three MFPs, the MFPs 1b and 1c have the same configurations as that of the MFP 1a.

The MFP 1a is provided with a CPU 10 configured to execute various kinds of processes to be executed by the MFP 1a, a ROM 12 configured to store a boot process program (BIOS) to be executed by the CPU 10 when booting the MFP 1a, a RAM 14 and non-volatile RAM 16 employed as memory areas when the CPU 10 executes the various kinds of processes, a hard disk drive (HDD) 18 configured to store programs for the various kinds of processes to be executed by the CPU 10, a printing portion 20 configured to print characters on a recording medium such as a printing paper, a reading portion 22 configured to read a character or an image recorded on a recording medium, operating keys 24 for inputting information, a liquid crystal display panel (LCD) 26 for displaying information, an external flash memory 28 configured capable of reading and writing information, a modem 34 for connecting the MFP 1a with a public line, and a communication portion 36 for connecting the MFP 1a with a network such as the LAN (Local Area Network) 80. The aforementioned constituent elements included in the MFP 1a are interconnected via a bus 40.

In addition, the MFP 1a includes an interface (not shown) for reading and writing the information stored in the external flash memory 28. The external flash memory 28 is configured easily detachable from the MFP 1a.

Further, the communication system in the illustrative aspect is configured such that address book data including telephone numbers, e-mail addresses, and facsimile numbers are shared between the MFPs 1a, 1b, and 1c. In the illustrative aspect, the address book data are stored in the non-volatile RAM 16. Moreover, the non-volatile RAM 16 is provided with an area in which an address of the MFP as the below-mentioned main MFP is to be registered.

Further, in the illustrative aspect, any one of the MFPs 1a, 1b, and 1c serves as an MFP that transfers the address book data to an MFP as an requesting source (hereinafter, referred to as the “main MFP”), when one of the other MFPs requests the address book data. Each of the MFPs other than the main MFP is an MFP that requests the address book data of the main MFP or an MFP other than itself (hereinafter, referred to as a “sub MFP”). In the MFPs other than the main MFP, the memory capacity of the non-volatile RAM 16 may be as small as possible to temporarily store the address book data from the main MFP.

Hereinafter, how the address book data are shared between the MFPs 1a, 1b, and 1c will be explained. It is noted that, here, processes according to the present invention are described in detail among the various kinds of processes to be executed by the CPU 10 of each of the MFPs 1a, 1b, and 1c. Further, in the following description, “the MFP” represents any of the MFPs 1a, 1b, and 1c.

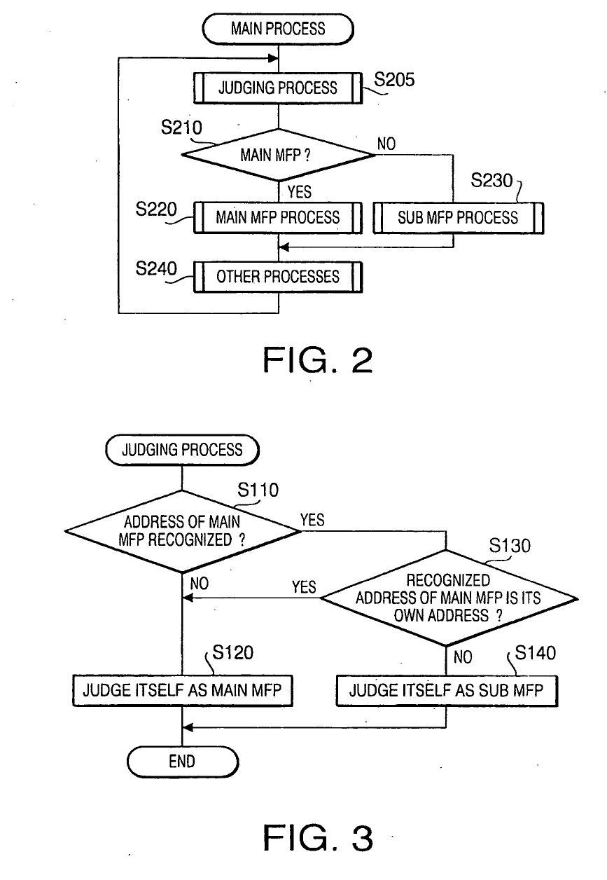

FIG. 2 is a flowchart showing a procedure of a main process to be executed by the CPU 10 of each of the MFPs 1a, 1b, and 1c. The main process is a process that is repeatedly executed when a power supply of the MFP is set ON.

In the main process, firstly, in a step of S205, a judging process is executed in which it is judged whether the MFP is the main MFP. The judging process will be explained with reference to a flowchart shown in FIG. 3. In the judging process, firstly, in a step of S110, it is judged whether an address of the main MFP can be recognized. More specifically, it is judged whether there is stored in the non-volatile RAM 16 of the MFP (itself) address information as the address of the main MFP. Namely, when the MFP is newly installed on the network, and a user has not registered the address of the main MFP using the operating keys 24, it is judged that the address of the main MFP cannot be recognized (S110: No), and that the MFP (itself) is the main MFP (S120). Thereafter, the judging process is terminated to bring the process to a step of S210 in FIG. 2. Meanwhile, when it is judged that the address of the main MFP can be recognized (S110: Yes) (i.e., when the user has registered an address of another MFP on the network as the main MFP, or the user has set the MFP (itself) as the main MFP, or the user has registered an address that had been received from another MFP as the main MFP), the process goes to a step of S130 to further judge whether the recognized address of the main MFP is the address of the MFP (itself). When it is judged that the recognized address is the address of the MFP (S130: Yes), the process goes to the step of S120 to judge that the MFP is the main MFP. Subsequently, the judging process is terminated to bring the process to the step of S210 in FIG. 2. Meanwhile, when it is judged that the recognized address is not the address of the MFP (S130: No), it is judged that the recognized address is an address of another MFP on the network, and the MFP is the sub MFP (S140). Thereafter, the judging process is terminated, and the process goes to the step of S210 in FIG. 2. It is noted that, in the illustrative aspect, the address is a MAC address, yet, hereinafter, it will simply be referred to as the address.

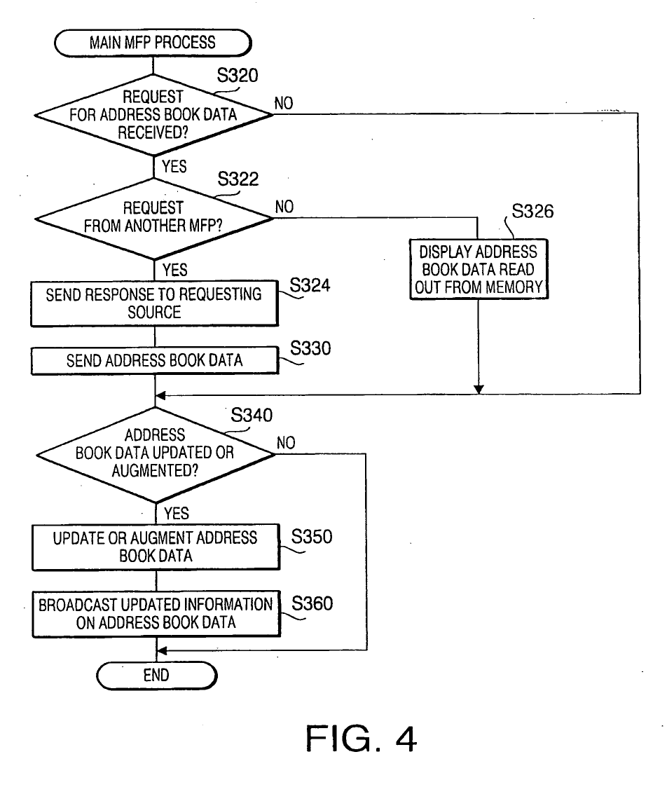

In the meantime, in the illustrative aspect, the user registers the address book data in an MFP set as the main MFP in the aforementioned judging process. Then, in processes (not shown) executed in the main and sub MFPs, the address book data registered in the main MFP are shared between the MFPs 1a, 1b, and 1c. More specifically, with the external flash memory 28 storing the address book data being connected to the main MFP, the address book data stored in the external flash memory 28 are read out by the main MFP, and are written into the non-volatile RAM 16. In addition, by the user operating the operating keys 24, the address book data are written as well (S350 in FIG. 4). It is noted that the configuration of the communication system is not limited to the aforementioned one. For example, the communication system may be configured such that an MFP in which the user has firstly registered the address book data serves as the main MFP.

In the step of S210 in FIG. 2, it is judged whether the MFP is the main MFP. When it is judged that the MFP is the main MFP in S210, i.e., it is judged that the MFP is the main MFP in the aforementioned judging process (S120), the process goes to a step of S220 to execute a main MFP process to be executed by the main MFP (see FIG. 4). It is noted that the main MFP process will be explained in detail below. Subsequently, the process goes to a step of S240.

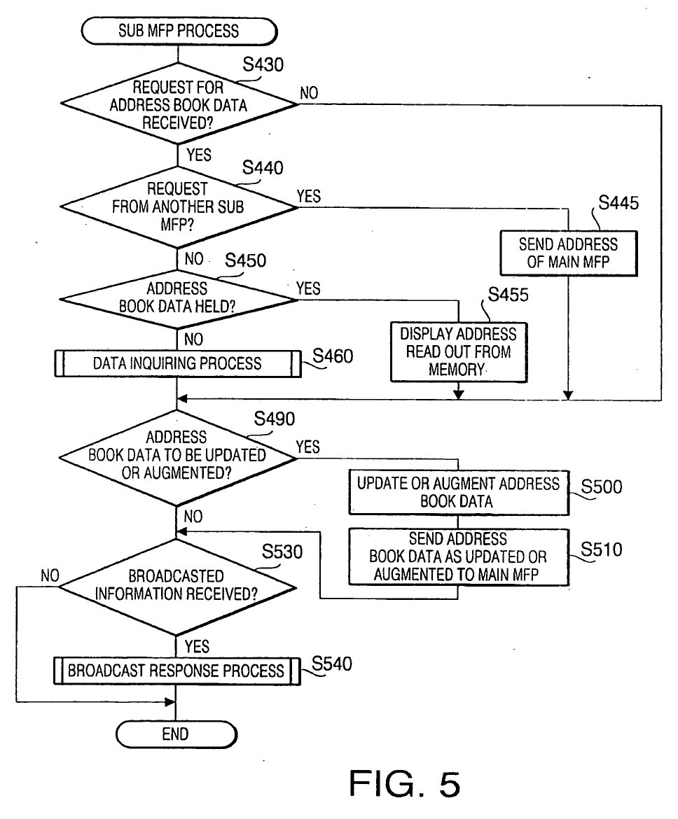

In the meantime, in the step of S210, when it is judged that the MFP is not the main MFP, i.e., it is judged that the MFP is a sub MFP in the aforementioned judging process (S140), the process goes to a step of S230 to execute a sub MFP process to be executed by the sub MFP (see FIGS. 5-8). It is note that the sub MFP process will be explained in detail below. Then, the process goes to the step of S240.

In the step of S240, other processes to be generally executed by the CPU 10 are executed. More specifically, the aforementioned other processes include a process for taking overall control of each of portions included in the MFP, a printing process to be generally executed by the MFP, and a process for reading an image. Further, the aforementioned other processes include such a process as to specify address book data from the address book data that are read out to be displayed in the below-mentioned step of S326 shown in FIG. 4 or S455 shown in FIG. 5, and call, send a fax to, or send an e-mail to a destination corresponding to each of the specified address book data. Subsequently, a process included in the aforementioned other processes in the step of S240 is terminated, and the main process goes back to the judging process in S205.

Next, the main MFP process in S220 and the sub MFP process in S230 will be described. First, the main MFP process will be explained referring to FIG. 4. In the main MFP process, firstly, in a step of S320, it is judged whether a request for the address book data has been received. When it is judged that the request for the address book data has been received (S320: Yes), the process goes to a step of S322 to judge whether the request has been sent from another MFP. Here, the request for the address book data may be sent from any one of the sub MFPs, and may be issued by the user.

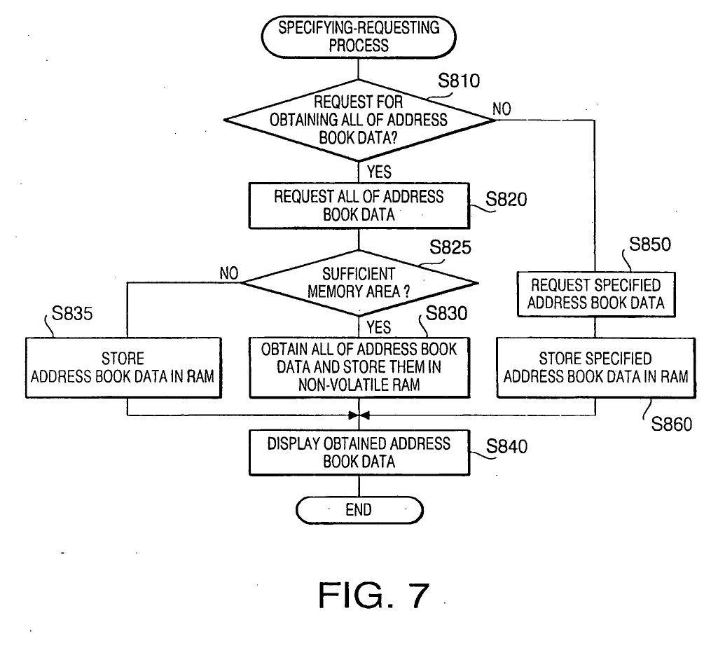

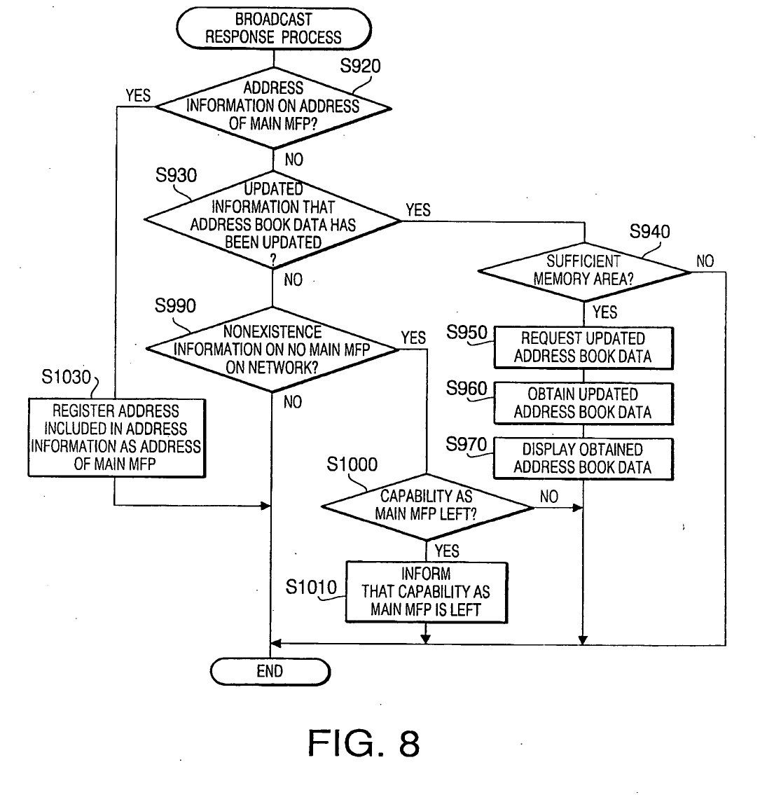

When it is judged that the request has been sent from another MFP, i.e., a sub MFP has sent the request for the address book data to the main MFP in the below-mentioned step of S820 or S850 shown in FIG. 7, or S950 shown in FIG. 8 (S322: Yes), a response to the request informing that the address book data will be sent is sent to the requesting source (S324). Subsequently, the requested address book data are sent to the requesting source (S330). Here, for example, when all of the address book data are requested, all of the address book data stored in the MFP are sent. Meanwhile, when specified address book data (e.g., all of address book data and e-mail addresses beginning with any of characters “A”, “I”, “U”, “E”, and “O”, and updated the address book data) are requested, the specified address book data are sent. In addition, the main MFP may previously check the memory capacity of the sub MFP and/or communication capability with the sub MFP to send segmented address book data in sequence in conformity to the memory capacity and communication capability. Then, when the transmission of the requested address book data has been completed, the process goes to a step of S340.

On the other hand, when it is not judged that the request has been sent from another MFP (S322: No), i.e., an instruction for requesting the address book data is inputted by the user operating the operating keys 24, the address book data stored in the non-volatile RAM 16 are read out to be displayed on the LCD 26 (S326). When the requested address book data are tow or more, all of the address book data can be displayed with a screen image of the LCD 26 being scrolled by the user operating the operating keys 24. Then, the address book data are displayed on the LCD 26, and the process goes to the step of S340. It is noted that, in the aforementioned process of S240. when any address is specified from the address book data displayed on the LCD 26 by the user, it is possible to communicate with a destination of a telephone number, a fax number, or an e-mail address corresponding to the specified address.

When the MFP serves as the main MFP in spite of the address book data being not stored in the non-volatile RAM 16 thereof (for example, the user has not registered any address book data, or the memory capacity is not enough), the address book data can not been sent or displayed. In such a case, a message informing of that may be sent or displayed.

When it is not judged that the request for the address book data has been received (S320: No), the process goes to the step of S340. In the step of S340, it is judged whether to update or augment predetermined address book data. Here, there are cases where the judgment is made based upon an input by the user, and it is made based upon communication with a sub MFP.

In the former case, i.e., in the case where the judgment is made based upon the input by the user, when, by the user operating the operating keys 24, the predetermined address book data are updated accompanied by an instruction for updating the predetermined address book data with the updated address book data being inputted, or the address book data are augmented, an positive judgment is made. In addition, when the user instructs to update or augment the address book data read out from the external flash memory 28, the positive judgment is made. In the latter case, i.e., in the case where the judgment is made based upon the communication with a sub MFP, when the updated address book data or the augmented address book data are sent to the main MFP from the sub MFP in the below-mentioned process of S510, the positive judgment is made.

Thereafter, when it is judged that the address book data are to be updated or augmented in the step of S340 (S340: Yes), the address book data are updated or augmented in a next step of S350. Here, it is noted that “updating the address book data means to overwrite the address book data before update with the updated address book data.

Subsequently, in a step of S360, updated information representing that the predetermined address book data have been updated and augmented is broadcasted to all of the devices (MFPs) on the network. Thereafter, the process is terminated to go to the step of S240. It is noted that, when the address book data cannot normally be updated or augmented in the non-volatile RAM 16 as the case where the MFP temporarily serves as the main MFP due to no communication device that can be the main MFP on the network, a predetermined error process may be carried out to terminated the process.

Meanwhile, when it is judged that the address book data are not to be updated or augmented in the step of S340 (S340: No), the process goes to the step of S240.

Next, the sub MFP process will be explained with reference to FIGS. 5 to 8. In the sub MFP process, firstly, in S430, it is judged whether a request for the address book data has been received. The judging process is the same process as that in the aforementioned step of S320 shown in FIG. 4. Namely, there are cases where the judgment is made based upon an input by the user, and it is made based upon communication with a sub MFP.

When it is judged that the address book data are stored in the non-volatile memory 16 of the MFP in the step of S430 (S430: Yes), next, it is judged whether the request for the address book data has been sent from another sub MFP in a step of S440. In the illustrative aspect, an address of the main MFP can previously be registered based upon operations by the user. However, at this time, an address of an appropriate device, i.e., an address of a device that serves as the main MFP is not necessarily registered. Further, the MFP has a possibility of registering an address of a sub MFP, which has registered an address of another MFP as that of the main MFP, as the address of the main MFP. In such a case, even when the MFP serves as the sub MFP, the MFP may receive the request for the address book data from another sub MFP. When it is judged that the request for the address book data has been sent from another MFP in the step of S440 (S440: Yes), since the MFP is a sub MFP, the MFP sends an address registered as the address of the main MFP in the non-volatile RAM 16 thereof to the requesting source (S445). The process then goes to a step of S490.

In the meantime, when it is not judged that the request for the address book data has been sent from another MFP in the step of S440, i.e., the request for the address book data has been issued by the user operating the operating keys 24 (S440: No), the process goes to a step of S450 to judge whether the address book data are held (stored) in the non-volatile memory 16 of the MFP. When it is judged that the address book data are stored in the non-volatile memory 16 of the MFP (S450: Yes), the address book data are read out from the non-volatile RAM 16 to be displayed on the LCD 26. Thereafter, the process goes to the step of S490. It is noted that the processes of reading out and displaying the address book data are the same as those in the step of S326 in the main MFP process. Accordingly, it is possible for the user to specify any address from the displayed address book data, and communicate with the destination corresponding to the specified address in the step of S240.

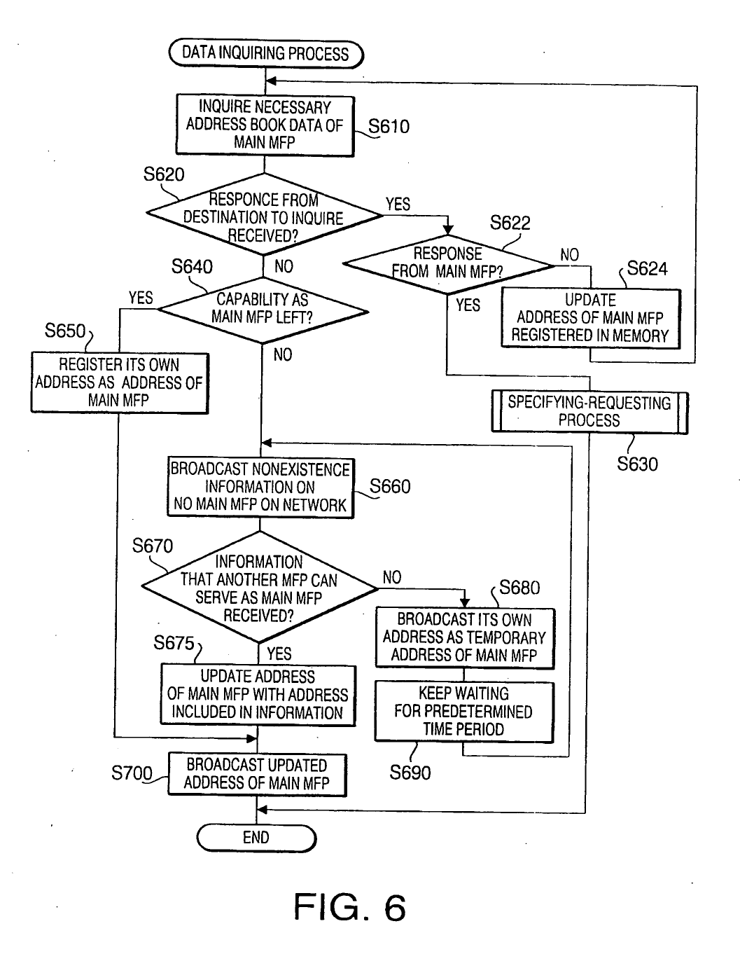

On the other hand, when it is not judged that the address book data are stored in the non-volatile memory 16 of the MFP (S450: No), the process goes to a data inquiring process in a step of S460. After completing the data inquiring process, the process goes to the step of S490. It is noted that the data inquiring process will be described in detail later see FIG. 6).

On the other hand, when it is not judged that the address book data are stored in the non-volatile memory 16 of the MFP (S430: No), the process immediately goes to the step of S490. Then, in the next step of S490, it is judged whether to update or augment the address book data based upon the input by the user. In this step, when it is not judged that the address book data are to be updated or augmented (S490: No), subsequently, the process goes to a step of S530.

Meanwhile, when it is judged that the address book data are to be updated or augmented in the step of S490 (S490: Yes), in a step of S500, the address book data stored in the non-volatile RAM 16 of the MFP are updated or augmented based upon the input by the user. It is noted that the update of the address book data in this step is performed by overwriting the address book data before update with the updated address book data.

Then, in a step of S510, the address book data as updated or augmented in the step of S500 are sent to the main MFP (the destination address stored as the address of the main MFP in the non-volatile RAM 16), and the process goes to a step of S530. In this step, when the address book data are sent, the positive judgment is made in the step of S340 in the main MFP process, so that the sent address book data are updated or augmented in the step of S350.

Thus, when the address book data are updated or augmented in the sub MFP, the address book data are sent to the main MFP. Thereby, the latest address book data are always held in the main MFP. Further, since information that the address book data have been updated or augmented in the main MFP is sent to all of the other sub MFPs in the step of S360, all of the other sub MFPs can soon obtain the latest address book data.

Subsequently, in the step of S530, it is judged whether information broadcasted from another MFP (the main MFP or another sub MFP) has been received. It is noted that the broadcasted information includes address information representing the address of the main MFP (S700), the updated information representing that the address book data have been updated or augmented (S360), and nonexistence information representing no main MFP on the network (S660). In this step, when it is not judged that any of those kinds of information has been received (S530: No), the process is terminated.

Meanwhile, when it is judged that the broadcasted information has been received in the step of S530 (S530: Yes), subsequently, the process goes to a step of S540, so that the below-mentioned broadcast response process, which is a process to be executed based upon the broadcasted information, is executed (see FIG. 8). Thereafter, the process is terminated to execute the aforementioned other processes in the step of S240 in FIG. 2.

Next, the data inquiring process to be executed in the step of S460 in FIG. 5 with reference to flowcharts shown in FIGS. 6 and 7. In the data inquiring process, firstly, in a step of S610, the necessary address book data are inquired of the main MFP. In this step, the main MFP represents an MFP corresponding to the address stored in the non-volatile RAM 16 of the MFP. It is noted that the necessary address book data are the address book data requested in the step of S430 in FIG. 5.

Subsequently, the process goes to a step of S620, and it is judged whether the main MFP (the MFP corresponding to the address registered as that of the main MFP in the non-volatile RAM 16) exists on the network. More specifically, when inquiring the necessary address book data in the step of S610, it is judged whether a predetermined response has been sent from the main MFP as an inquired destination. The positive judgment is made that the main MFP exists on the network when the response has been received. Meanwhile, negative judgment is made that the main MFP does not exist on the network when the response has not been received.

When the positive judgment is made in the step of S620, subsequently, in a step of S622, it is judged whether an MFP that has sent the response is the main MFP. Namely, an MFP corresponding to the address registered in the MFP may be a sub MFP, and, in such a case, the response that has been sent from the MFP as the inquired destination includes the address information on the address of the main MFP sent in the step of S445 in FIG. 5. Accordingly, when the response includes the address information on the address of the main MFP (S622: No), the received new address is registered and stored as the address of the main MFP in the non-volatile RAM 16 (S624). Further, the process goes back to the step of S610 to inquire the necessary address book data of the newly registered address as that of the main MFP again.

In the meantime, when the MFP that has sent the response is the main MFP, namely, when the response includes information that the address book data are to be updated (S622: Yes), subsequently, the process goes to a step of S630, and a specifying-requesting process for specifying the address book data for the main MFP and requesting the specified address book data is executed.

The specifying-requesting process to be executed in the step of S630 will be described with reference to a flowchart shown in FIG. 7. In the specifying-requesting process, firstly, in a step of S810, it is judged whether the request, which has positively been judged to be received in the step of S430, is for requesting all of the address book data. It is noted that, when the user requests the address book data by operating the operating keys 24, a selecting screen image for inquiring whether to obtain all of the address book data is displayed on the LCD 26. Therefore, the user can select one between all of the address book data and the specified address book data on the displayed screen image by operating the operating keys 24. Then, the judging process in S810 is executed in accordance with the selected option (in other words, the requested matter).

In this step, when it is judged that the request is for requesting all of the address book data (S810: Yes), the process goes to a step of S820 to request all of the address book data of the main MFP. In response to the request, the main MFP sends the requested address book data (S330 in FIG. 4). Then, it is judged whether a sufficient memory area of the non-volatile RAM 16 of the MFP is left in a next step of S825. The judgment whether a sufficient memory area is left is made based upon judgment whether it is possible to store all of the address book data to be received in the non-volatile RAM 16. In this step, when it is judged that the sufficient memory area is left (S825: Yes), in a next step of S830, the sent address book data are obtained to be stored in the non-volatile RAM 16. Meanwhile, when it is not judged that the sufficient memory area is left (S825: No), the address book data are temporarily stored in the RAM 14 (S835). Thereafter, the address book data stored in the non-volatile RAM 16 or the RAM 14 are displayed on the LCD 26 (S840).

In the meantime, when a memory area of the RAM 14 is not sufficient in the step of S835, the address book data may be received and displayed by predetermined number of addresses (e.g., ten addresses). Namely, such an operation that a subsequent predetermined number of addresses are received from the main MFP to be stored in the RAM 14 and displayed in response to the user requesting the subsequent predetermined number of addresses by operating the operating keys 14 may repeatedly be performed.

On the other hand, when it is not judged that the request is for requesting all of the address book data (S810: No), the process goes to a step of S850, so as to request the specified address book data (e.g., address book data including all of address book data and e-mail addresses beginning with any of characters “A”, “I”, “U”, “E”, and “O”) based upon an input by the user. In response to the request, the main MFP sends the specified address book data corresponding to the request (S330 in FIG. 4). Then, in a next step of S860, the specified address book data that has been sent from the main MFP are obtained and stored in the RAM 14.

Thereafter, in a step of S840, information representing the obtained address book data is displayed on the LCD 26 of the MFP as well as information representing that the address book data have been obtained. Then, the process goes to the step of S490 in FIG. 5. It is noted that, regarding the address book data to be displayed in the step of S840, it is possible for the user to specify any address from the displayed address book data, and communicate with a telephone number, a fax number, and an e-mail address corresponding to the specified address (S240).

It is noted that the address book data stored in RAM 14 are temporarily stored, and are deleted from the RAM 14 after completing the processes in the step of S240 in FIG. 2. Therefore, the necessary address book data are requested at timing when the necessary address book data are necessary, which allows even the MFP with an insufficient memory area to efficiently use the address book data of the main MFP. On the other hand, since the address book data stored in the non-volatile RAM 16 cannot be deleted, when the user requests the address book data next time (S430: Yes), the address book data can be obtained from the non-volatile RAM 16 of the MFP (S455).

In the meantime, when the negative judgment is made in the step of S620 in FIG. 6, namely, when it is not judged that the main MFP exists on the network, next, the process goes to a step of S640. The case where the main MFP does not exist on the network may be caused by that the main MFP that had existed on the network has been removed for some sort of reason. In such a case, since it is necessary to register a new main MFP, it is judged whether there is left in the MFP a capability necessary for being the main MFP (e.g., a computing power and storage capacity) (S640). Namely, it is judged whether the MFP can serve as the main MFP, which presently does not exist. In this step, when it is judged that there is left in the MFP the necessary capability (S640: Yes), subsequently, the process goes to a step of S650.

In the step of S650, the address of the MFP is registered as a new address of the main MFP in the MFP. In other words, the MFP is set to serve as a new main MFP. Subsequently, the process goes to a step of S700. Then, the new address of the main MFP (i.e., the address of the MFP) is broadcasted to all of the devices (MFPs) on the network.

On the other hand, when negative judgment is made in the step of S640, i.e., when it is judged that the MFP cannot serve as the main MFP, the process then goes to the step of S660 to broadcast nonexistence information representing no main MFP on the network to all of the MFPs on the network. It is noted that the nonexistence information includes an instruction for instructing each of the other sub MFPs to serve as the main MFP.

In a step of S670, it is judged whether information representing that another sub MFP can serve as the main MFP has been received which is to be sent from the aforementioned another sub MFP in response to the nonexistence information broadcasted in the step of S660. The information is to be sent in the below-mentioned step of S1010 in FIG. 8, including information on the address of the MFP sending the information. When it is judged that the information, which represents that another MFP can serve as the main MFP and includes the information on the address thereof, has been received, the address of the main MFP stored in the non-volatile RAM 16 of the MFP is updated with the received new address (S675). Subsequently, the process goes to a step of S700 to broadcast the received new address as the address of the main MFP to the other MFPs on the network.

On the other hand, when it is not judged that the information that another MFP can serve as the main MFP has been received from the network in a predetermined waiting time period (S670: No), it is judged that there is not left in any of the sub MFPs the capability necessary for serving as the main MFP. Then, in a next step of S680, the MFP is set as a temporary main MFP, so as to broadcast the address of the MFP as an address of the temporary main MFP to all of the MFPs on the network. It is noted that, in the illustrative aspect, as the temporary main MFP has limited functions, for example, the temporary main MFP cannot update or augment the address book data. Thereafter, the process goes back to the step of S660 after keeping waiting for a predetermined time period. Namely, the nonexistence information representing no main MFP on the network is broadcasted every the predetermined time period, requesting the other MFPs to be the main MFP Therefore, when a new MFP having the capability necessary for being the main MFP is connected to the network, the new MFP can be set to serve as the main MFP. Thereby, a process such as processes of updating and augmenting the address book data can be executed. When completing a step of S700, the process goes to the step of S490.

Next, a broadcast response process to be executed in the step of S540 in FIG. 5 will be explained referring to a flowchart shown in FIG. 8. In the broadcast response process, firstly, in a step of S920, it is judged whether the received information is address information representing the address of the main MFP. It is noted that the address information on the address of the main MFP is address information on the address of the new main MFP broadcasted in the step of S700. When the received information is judged to be the address information representing the address of the main MFP (S920: Yes), the process goes to a step of S1030.

In the step of S1030, based upon the address information, the address of the main MFP stored in the MFP is updated with the received new address. Meanwhile, when the received information is not judged to be the address information representing the address of the main MFP (S920: No), the process goes to a step of S930 to judge whether the received information is the updated information (S360) representing that the address book data have been updated sent from the MFP that has registered the address thereof as that of the main MFP. When the received information is judged to be the updated information (S930: Yes), the process goes to a step of S940.

In the step of S940, it is judged whether the memory area is sufficient in the non-volatile RAM 16 of the MFP. More specifically, it is judged whether there is left in the non-volatile RAM 16 a vacant memory area more than a predetermined amount that is previously defined necessary for storing the updated address book data. It is noted that the updated information includes information on the data amount of the updated address book data.

When the memory area is not judged sufficient in the step of S940 (S940: No), the process is terminated. In the meantime, when the memory area is judged sufficient in the step of S940 (S940: Yes), the process goes to a step of S950 request the updated address book data of the main MFP. In response to the request, the main MFP sends the updated address book data (S330 in FIG. 4), and the address book data sent from the main MFP are obtained in a subsequent step of S960.

In a next step of S970, information representing that the address book data have been obtained is displayed on the LCD 26 for a predetermined time period together with the information representing the address book data. Thereafter, the process is terminated.

Meanwhile, when the received information is not judged to be the updated information (S930: No), the process goes to a step of S990 to judge whether the received information is the nonexistence information representing no main MFP on the network. In this step, when the received information is judged to be the nonexistence information (S990: Yes), it is judged that no main MFP exists on the network, and the process goes to a step of S100.

In the step of S1000, it is judged whether there is left in the MFP a capability necessary for being the main MFP (e.g., a memory area for storing the address book data, and a computing power for serving as the main MFP) (S640), i.e., whether the MEP can serve as the main MFP. In this step, when it is not judged that the MFP can serve as the main MFP (S1000: No), the process is terminated.

Meanwhile, when it is judged that the MFP can serve as the main MFP in the step of S1000 (S1000: Yes), the process goes to a step of S1010 to send the address information on the address of the MFP as well as information that the MFP can serve as the main MFP to the sub MFP that has sent the nonexistence information. At this time, the sub MFP as the sending source makes positive judgment in the step of S670, and broadcasts the address thereof as a new address of the main MFP to all of the MFPs on the network. Then, after completing the step of S1010, the process is terminated. In addition, when the received information is not judged to be the nonexistence information (S990: No), the process is terminated.

Next, the operation of the communication system will be explained. Here, the explanation will be given about a case where the MFP 1a serves as the main MFP, and each of the MFPs 1b and 1c serves as the sub MFP.

First, in the MFP 1b, when the operating keys 24 are operated by the user such that an instruction for requesting the address book data is inputted, it is judged that the request for the address book data has been received (S430: Yes, S440: No). Further, when the MFP 1b does not hold the requested address book data (S450: No), the MFP 1b requests the address book data of the MFP 1a (S630). It is noted that, at this time, the MFP 1b judges whether the MFP 1a exists on the LAN 80 (S620), and when the MFP 1b judges that the MFP 1a exists on the LAN 80, the MFP 1b requests the address book data of the MFP 1a.

When there are two or more address book data, the MFP 1b specifies address book data to request of the MFP 1a, and requests the specified address book data (S820 and S850). In response to the request, the MFP 1a judges that the request for the address book data have received from the MFP 1b (S320: Yes), and sends the requested address book data to the MFP 1b (S330).

When the address book data are thus requested of the MFP 1a by the MFP 1b, the requested address book data are sent to the MFP 1b from the MFP 1a. Namely, the MFP 1b can obtain necessary address book data in a timely fashion when the MFP 1b wants them.

In addition, when the address book data are sent to the MFP 1b from the MFP 1a, the MFP 1b is always ready to receive the data to be shared. For this reason, the address book data are certainly sent and received. Thereby, the address book data are smoothly shared.

In the meantime, when the predetermined address book data are updated or augmented in the MFP 1b (S500), the MFP 1b sends the updated or augmented address book data to the MFP 1a (S510). Then, the MFP 1a receives the address book data to update or augment them (S350), and sends the updated information representing that the predetermined address book data have been updated or augmented to the MFPs 1b and 1c (S510).

At this time, the MFP 1c can know that the predetermined address book data have been updated or augmented (S930: Yes). Further, the MFP 1c can request the address book data of the MFP 1a in a timely fashion when the MFP 1c wants them. In this way, when the address book data are updated or augmented in the sub MFP (or the main MFP), the updated or augmented address book data are smoothly shared.

In addition, the MFP 1b judges whether the MFP 1a exists on the LAN 80 when requesting the address book data of the MFP 1a (S620). At this time, when the MFP 1a is not judged to exist on the LAN 80, it is judged whether the MFP 1b can serve as the main MFP (S640). When the MFP 1b judges itself to be able to serve as the main MFP, the MFP 1a sets itself as the main MFP to inform the MFP 1c of the address thereof as a new address of the main MFP (S700).

For example, when the MFP 1a cannot function due to some sort of trouble, even though the request for the address book data is sent to the MFP 1a from the MFP 1c, the MFP 1a cannot respond to the request as the MFP 1a cannot function. Consequently, continuous transmission of the request from the MFP 1c may cause a communication channel to be occupied, or the MFP 1c to freeze. However, in the illustrative aspect, since the MFP 1b serves as the main MFP on behalf of the MFP 1a in such a case, such a problem can never be caused.

In addition, when the MFP 1b cannot serve as the main MFP (S640: No), the MFP 1b instructs the MFP 1c to be the main MFP (S660). Here, when the MFP 1c can serve as the main MFP (S640: Yes), the MFP 1c serves as the main MFP (S650).

Thus, when the main MFP does not exist on the LAN 80, any of the sub MFPs substitutes as the main MFP. Therefore, more reliable communication system can be established. In addition, for example, when the MFP 1c is connected to the LAN 80 later, and, at that time, the MFP 1c registers the MFP 1b as the main MFP in spite of the MFP 1a existing as the main MFP, the address of the MFP 1a is sent to the MFP 1c from the MFP 1b in response to the request for the address book data sent to the MFP 1b from the MFP 1c (S480).

Accordingly, if each of the MFPs can recognize one MFP on the LAN 80, each of the MFPs can share the address book data with the other MFPs. Therefore, the address book data are certainly shared among the MFPs.

Hereinabove, the illustrative aspect according to the present invention has been explained. However, the present invention is not limited to the aforementioned illustrative aspect, and various sorts of modifications may be possible as far as they are within a technical scope of the present invention. In the aforementioned illustrative aspect, the communication system is configured with the MFPs. However, for example, any sort of communication devices, which can communicate, such as printers, scanners, and personal computers can be applied to the present invention, and cause the same effect as the MFPs.

In addition, although the address book data are shared as the shared data in the aforementioned illustrative aspect, any sort of data that can be sent and received between the communication devices may be applied.

In the aforementioned illustrative aspect, the MFP as the sub MFP is configured to request the address book data of the main MFP based upon the input by the user. However, the sub MFP may be configured to automatically request the address book data of the main MFP. In this case, the sub MFP may be configured to select the address book data to request, or request the address book data that the main MFP frequently uses depending on the storage capacity thereof to spare.

In the aforementioned illustrative aspect, when the request for the address book data is sent to a sub MFP (as a destination of the request) from another sub MFP (as a requesting source), the information representing the address of the main MFP is sent to the sub MFP as the requesting source from the sub MFP as the destination of the request. However, the address book data may directly be sent to the sub MFP as the requesting source from the sub MFP as the destination of the request.

Further, when the sub MFP registers the address of the main MFP, the sub MFP may inquire the main MFP whose address is to be registered in the sub MFP whether the sub MFP can share the address book data with the main MFP. In this case, when the sub MFP receives a response representing that the sub MFP can share the address book data with the main MFP from the main MFP as the destination of the inquiry in response to the inquiry, i.e., when the destination of the inquiry can serve as the main MFP, the sub MFP may register the address of the main MFP. In such a case, such a trouble that the main MFP is wrongly registered due to a mistake in the registration of the address of the main MFP can be solved when registering the address of the main MFP in response to the inquiry. Further, in such a configuration, the inquiry as to whether the sub MFP can share the address book data with the main MFP and the request for the address book data may be sent at the same time. In the case of sending the inquiry and the request at the same time, the request for the address book data may be sent when the sub MFP as the requesting source has the storage capacity to spare sufficient for storing the address book data. In addition, when the main MFP receives the inquiry as to whether the sub MFP can share the address book data with. the main MFP from the sub MFP, the main MFP may register the address of the sub MFP. When the address book data are updated or augmented, the main MFP may inform the sub MFP whose address is registered in the main MFP that the address book data are updated or augmented.

Further, in the illustrative aspect, the sub MFP broadcasts the nonexistence information representing no main MFP on the network to all of the other sub MFPs on the network, and when the sub MFP receives the response to the broadcasted information from any of the other MFPs, the sub MFP registers the MFP that has sent the response as the main MFP. However, the sub MFP may broadcast the nonexistence information to sub MFPs that have registered the same address as the address of the main MFP that the sub MFP has registered. Thereby, for example, when there are two or more main MFPs on the network, and the address book data are managed in each of groups into which all of the MFPs on the network are divided for each of the main MFPs, the address book data cannot be shared between the MFPs in and outside a group. Therefore, the address book data, such as a telephone number and e-mail address, can be prevented from being leaked to a third party, and can be shared with an appropriate device (MFP).

In addition, the area storing the address book data is not limited to the non-volatile RAM, and may be an HDD or an external flash memory.

What is claimed is:

1. A communication system comprising a plurality of communication terminal devices interconnected via a network, the communication system being configured such that information can be sent and received between the plurality of communication terminal devices,
wherein the plurality of communication terminal devices comprise:
a first communication terminal device including:
a first storing system configured to store shared data to be shared among the plurality of communication terminal devices; and
a first response system configured to send the shared data stored in the first storing system to another communication terminal device, in response to a request for the shared data being received from said another communication terminal device; and
a second communication terminal device including:
a requesting system configured to request the shared data of the first communication terminal device; and
an obtaining system configured to obtain the shared data to be sent from the first communication terminal device in response to the requesting system requesting the shared data of the first communication terminal device.

2. The communication system according to claim 1,
wherein the first storing system is configured to store a plurality of shared data as the shared data, and
wherein the second communication terminal device further includes a specifying system configured to specify shared data to be requested by the requesting system from the plurality of shared data, and
wherein the requesting system is configured to request the shared data specified by the specifying system of the first communication terminal device, and
wherein the first response system is configured to send the shared data specified by the specifying system to the second communication terminal device.

3. The communication system according to claim 1,
wherein the second communication terminal device further includes:
an updating system configured to update the shared data obtained by the obtaining system; and
a sending system configured to send the shared data updated by the updating system to the first communication terminal device, in response to the updating system updating the shared data, and
wherein the first communication terminal device further includes a notifying system configured to send information representing that the shared data have been updated to the other communication terminal devices, in response to the shared data as updated being received from the second communication terminal device.

4. The communication system according to claim 1,
wherein the second communication terminal device further includes:
a second storing system configured to store shared data to be shared among the plurality of communication terminal devices;
a second response system configured to send the shared data stored in the second storing system to another communication terminal device, in response to a request for the shared data being received from said another communication terminal device;
a judging system configured to judge whether the first communication terminal device exists on the network, when the requesting system requests the shared data of the first communication terminal device; and
a setting system configured to set the second communication terminal device to serve as the first communication terminal device, in response to the judging system judging that none of the first communication terminal device exists on the network.

5. The communication system according to claim 1,
wherein the second communication terminal device further includes:
a judging system configured to judge whether the first communication terminal device exists on the network, when the requesting system requests the shared data of the first communication terminal device; and
an instruction sending system configured to send an instruction for instructing any of the other communication terminal devices on the network to serve as the first communication terminal device, in response to the judging system judging that none of the first communication terminal device exists on the network.

6. The communication system according to claim 1, further comprising a third communication terminal device configured capable of requesting the shared data of another communication terminal device,
wherein the second communication terminal device further includes an informing system configured to send information representing an address of the first communication terminal device to the third communication terminal device in response to the third communication terminal device requesting the shared data of the second communication terminal device, and
wherein the third communication terminal device is configured to request the shared data of the first communication terminal device corresponding to the address represented by the information sent from the informing system.

7. The communication system according to claim 1,
wherein the shared data include at least one of a telephone number, an e-mail address, and a facsimile number that are set communicable between the plurality of communication terminal devices.

8. A communication terminal device included in a communication system that is configured with a plurality of communication terminal devices interconnected via a network such that information can be sent and received between the plurality of communication terminal devices, the communication terminal device, comprising:
a storing system configured to store shared data to be shared among the plurality of communication terminal devices; and
a response system configured to send the shared data stored in the storing system to another communication terminal device, in response to a request for the shared data being received from said another communication terminal device.

9. A communication terminal device included in a communication system that is configured with a plurality of communication terminal devices interconnected via a network such that information can be sent and received between the plurality of communication terminal devices, the communication terminal device, comprising:
a requesting system configured to request shared data of a first communication terminal device that includes a storing system configured to store the shared data to be shared among the plurality of communication terminal devices; and
an obtaining system configured to obtain the shared data to be sent from the first communication terminal device in response to the requesting system requesting the shared data of the first communication terminal device.

10. A computer usable medium comprising instructions configured readable by a computer, the computer being interconnected with at least one communication terminal device via a network, the computer having a storing system configured to store shared data to be shared with the at least one communication terminal device, the instructions causing the computer to serve as:
a response system configured to send the shared data stored in the storing system to the at least one communication terminal device, in response to a request for the shared data being received from the at least one communication terminal device;
a requesting system configured to request the shared data of the at least one communication terminal device; and
an obtaining system configured to obtain the shared data to be sent from the at least one communication terminal device in response to the requesting system requesting the shared data of the at least one communication terminal device.
